(19) United States
(12) Patent Application Publication
(10) Pub. No.: US 2025/0021810 A1
(43) Pub. Date: Jan. 16, 2025

(54) MULTI-NODAL DECISION TREES AND NEURAL NETWORKS IN MODEL SELECTION PROCESSES

(71) Applicant: Wells Fargo Bank, N.A., San Francisco, CA (US)

(72) Inventors: Qun Luo, San Francisco, CA (US); Andrew Mack, San Francisco, CA (US)

(21) Appl. No.: 17/143,010

(22) Filed: Jan. 6, 2021

(51) Int. Cl. G06N 3/08; G06F 16/2457; G06F 40/205

(52) U.S. Cl. CPC G06N 3/08; G06F 16/24578; G06F 40/205

(57) ABSTRACT

Disclosed is an approach to model selection including receiving a splitting function, a stopping criterion, at least one attribute selection, and a target variable. A decision tree may be generated, including processing a training data set to create a node that splits the training data set on an attribute from the at least one selected attribute, splitting the node according to the splitting function, and repeating the generation until the stopping criterion is met. A plurality of models may be processed through the generated decision tree, and a determination regarding the target variable made for each model. A subset of models may be selected based on the determination of the target variable, and a category parameter and a designation of at least one model may be received. Documents associated with the designated models may be retrieved and analyzed via NLP and ranked based on the NLP and the category parameter.

### TECHNICAL FIELD

The present disclosure relates to application of machine learning to data model selection processes involving multi-nodal neural networks and/or decision trees to identify and select data models to be reviewed for validity.

### BACKGROUND

Data models are used extensively to gain insight into various patterns, such as patterns in data on users and transactions. User financial patterns, for example, may include transaction frequencies, cash flow, and a user's proclivity to pay bills in a timely manner. However, identifying data models that may require validity or other review lacks a standardized and reliable approach that reduces subjectivity and enhances reliability.

### SUMMARY

Various embodiments relate to a method for model selection, the method comprising: receiving, by a provider institution computing system, a first user input comprising a splitting function, a stopping criterion, at least one attribute selection, and a target variable; generating, by the provider institution computing system, a decision tree based on the received first user input, wherein generating includes processing a training data set to: create a node that splits the training data set on an attribute from the at least one selected attribute; split the node according to the splitting function; and repeat the generation until the stopping criterion is met; processing, by the provider institution computing system, a plurality of models through the generated decision tree, wherein processing includes a determination about the target variable for each model from the plurality; selecting, by the provider institution computing system, a subset of models from the plurality based on the determination of the target variable; providing, by the provider institution computing system, the subset of selected models to a user; receiving, by the provider institution computing system, a second user input comprising a category parameter and a designation of at least one model from the subset of selected models; retrieving, by the provider institution computing system, a plurality of documents associated with the designated at least one model; analyzing, by the provider institution computing system, the plurality of documents via a natural language processing (NLP) algorithm; ranking, by the provider institution computing system, the plurality of documents based on the NLP analysis and the received category parameter; and providing, by the provider institution computing system, the ranked plurality of documents to the user.

Various embodiments relate a model selection computing system comprising: a machine learning circuit; a natural language processing (NLP) circuit; a model database; a model risk database; and a processing circuit configured to: receive a first user input comprising a splitting function, a stopping criterion, at least one attribute selection, and a target variable; generate a decision tree based on the received first user input, wherein generating includes processing a training data set to: create a node that splits the training data set on an attribute from the at least one selected attribute; split the node according to the splitting function; and repeat the generation until the stopping criterion is met; process a plurality of models through the generated decision tree, wherein processing includes a determination about the target variable for each model from the plurality; select a subset of models from the plurality based on the determination of the target variable; provide the subset of selected models to a user; receive a second user input comprising a category parameter and a designation of at least one model from the subset of selected models; retrieve a plurality of documents associated with the designated at least one model; analyze the plurality of documents via a natural language processing (NLP) algorithm; rank the plurality of documents based on the NLP analysis and the received category parameter; and provide the ranked plurality of documents to the user.

Various embodiments relate to a non-transitory computer-readable medium comprising instructions stored thereon that, when executed by a processor of a computing system, cause the computing system to perform operations comprising: receive a first user input comprising a splitting function, a stopping criterion, at least one attribute selection, and a target variable; generate a decision tree based on the received first user input, wherein generating includes processing a training data set to: create a node that splits the training data set on an attribute from the at least one selected attribute; split the node according to the splitting function; and repeat the generation until the stopping criterion is met; process a plurality of models through the generated decision tree, wherein processing includes a determination about the target variable for each model from the plurality; select a subset of models from the plurality based on the determination of the target variable; provide the subset of selected models to a user; receive a second user input comprising a category parameter and a designation of at least one model from the subset of selected models; retrieve a plurality of documents associated with the designated at least one model; analyze the plurality of documents via a natural language processing (NLP) algorithm; rank the plurality of documents based on the NLP analysis and the received category parameter; and provide the ranked plurality of documents to the user.

### BRIEF DESCRIPTION OF THE FIGURES

FIG. 1 is a schematic diagram of a model selection computing system, according to an example embodiment;

FIG. 2 is a flow diagram of a method of using a decision tree to select models for risk review, according to an example embodiment;

FIG. 3 is a user device graphical user-interface displayed as part of a model selection process, according to an example embodiment; and

FIG. 4 is an illustrative example of a linear decision process produced by a decision tree, according to an example embodiment.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the Figures, systems and methods for selecting data models and ranking their associated documents, as part of a review or audit process, are described herein according to various embodiments. In particular, the innovations described herein relate to systems and methods for selecting data models via machine learning algorithms, such as a decision tree and/or neural networks.

In various embodiments, a clear and consistent process is employed for identifying and prioritizing models selected for review based on a greater number of factors, making clear, comprehensive, and consistent decision that are both justifiable and traceable. Each node in decision trees and/or neural networks may be turned on or off (e.g., “yes” or “no”), and linear combinations of the logics, values, and/or criteria can be used at user discretion (in its preceding layer order) for model selection. Previously, such selection processes have been subjective and not consistent from person to person, and use of decision trees and/or neural networks can provide structure and yield consistency and traceability of decision steps to arrive at the final decisions. The disclosed prioritizing model selection process is expandable to any decision process requiring rank ordering or justification.

Various improvements to model risk reviews and audits are described herein. Typically, a financial institution desiring to select high-risk data models for review is subject to human error. Specifically, there may be a team, or even many teams (and therefore layers to the review process) that select data models. Application of machine learning according to various disclosed embodiments provides far more accurate, objective, and repeatable audits.

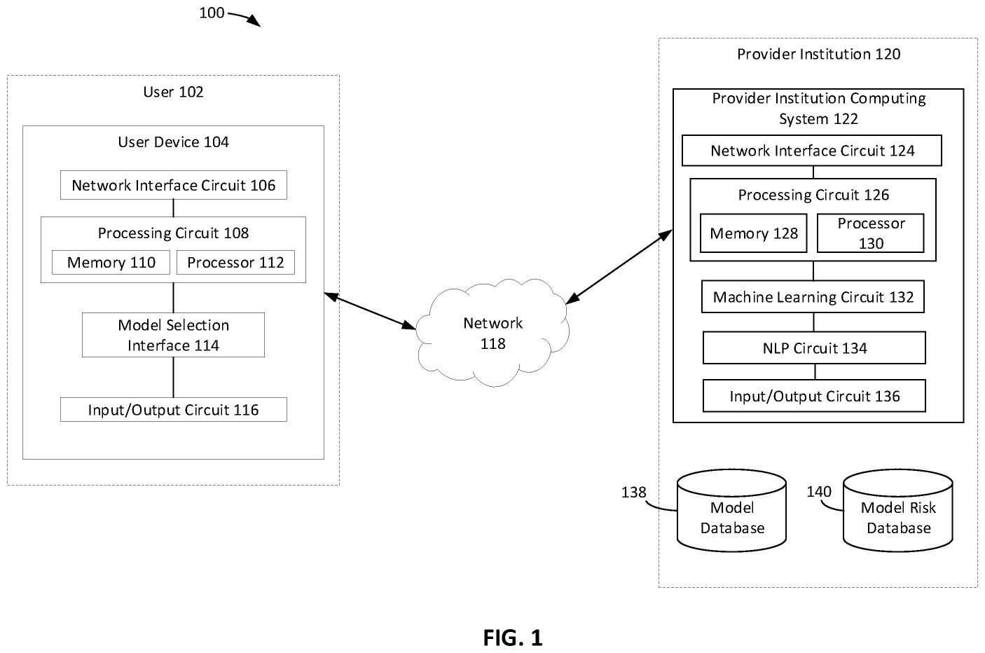

Referring now to FIG. 1, a schematic diagram of a model selection computing system 100 is shown, according to an example embodiment. The model selection computing system 100 includes a user device 104 and a provider institution computing system 122. The user device 104 and the provider institution computing system 122 are each communicably coupled and configured to exchange information over a network 118, which may include one or more of the Internet, cellular network, Wi-Fi, Wi-Max, a proprietary banking network, a proprietary retail or service provider network, or other type of wired or wireless network.

The user device 104 may be a computing device associated with a user 102 (e.g., owned by, used by, etc.). The user device 104 may be or include a desktop computer, a mobile phone, a tablet, a laptop, and/or other suitable user computing devices capable of accessing and communicating using local and/or global networks (e.g., the network 118). Wearable computing devices refer to types of devices that an individual wears, including, but not limited to, a watch (e.g., a smart watch), glasses (e.g., eye glasses, sunglasses, smart glasses, etc.), bracelet (e.g., a smart bracelet), etc.

The user 102 may be an employee, a contractor, or a client of the provider institution associated with the provider institution computing system 122 (e.g., a client of a model selection service). Accordingly, the user 102 may be an individual, a representative(s) of a small or large business entity, and any other authorized customer of the provider institution (e.g., authorized to access a model selection service).

The user device 104 is shown to include a network interface circuit 106, a processing circuit 108, a model selection interface 114, and an input/output circuit 116. The network interface circuit 106 is structured to establish connections with other computing systems (e.g., the provider institution computing system 122) via the network 118. Accordingly, the network interface circuit 106 enables the user device 104 to transmit and/or receive information to and/or from the provider institution computing system 122 over the network 118. The network interface circuit 106 includes program logic that facilitates connection of the user device 104 to the network 118. For example, the network interface circuit 106 may include a combination of wireless network transceivers (e.g., a cellular modem, a NFC transceiver, a Bluetooth transceiver, a Wi-Fi transceiver, etc.) and/or a wired network transceivers (e.g., an Ethernet transceiver). In some arrangements, the network interface circuit 106 includes the hardware and machine-readable media sufficient to support communication over multiple channels of data communication. Further, in some arrangements, the network interface circuit 106 includes cryptography capabilities to establish a secure or relatively secure communication session in which data communicated over the session is encrypted.

The processing circuit 108 includes a memory 110 and a processor 112. The memory 110 may be one or more memory or storage devices (e.g., RAM, ROM, Flash memory, hard disk storage) for storing data and/or computer code for completing and/or facilitating the various processes described herein. Memory 110 may be or include non-transient volatile memory, non-volatile memory, and non-transitory computer storage media. Memory 110 may include database components, object code components, script components, or other types of information structured for supporting the various activities and information structures described herein. The memory 110 may be coupled to the processor 112 and include computer code or instructions for executing one or more processes described herein. The processor 112 may be implemented as one or more processors, application specific integrated circuits (ASICs), field programmable gate arrays (FPGAs), a group of processing components, or other suitable electronic processing components. As such, the user device 104 is configured to run a variety of application programs and store associated data in the memory 110. One such set of executable computer code may be the model selection interface 114.

The user device 104 includes a model selection interface 114 that is provided by and coupled to the provider institution computing system 122. In some arrangements, the model selection interface 114 may be an application or be incorporated with an existing application of the user device 104 (e.g., integrated into an employee software suite, etc.). In other arrangements, the model selection interface 114 may be accessed via a web browser (e.g., Mozilla Firefox ™, Google Chrome ™, etc.) as part of a software as a service (SaaS) model. That is, the model selection interface 114 may be structured to interact with a webserver that provides an application programming interface (API) on behalf of the provider institution 120, and communicatively coupled to the provider institution computing system 122. The model selection interface 114 may be downloaded by the user device 104 prior to its usage, hard coded into the memory 110 of the user device 104, or be a network-based or web-based interface application such that the provider institution computing system 122 may provide a web browser to access the application, which may be executed remotely from the user device 104. The model selection interface 114 may be developed and maintained (e.g., provided with software updates on a regular or semi-regular basis) by the provider institution 120 using the provider institution computing system 122. Accordingly, the user device 104 may include software and/or hardware capable of implementing a network-based or web-based application. For example, in some instances, the model selection interface 114 includes software such as HTML, XML, WML, SGML, PHP (Hypertext Preprocessor), CGI, and like languages.

In the latter web-based instance, the user 102 may have to log onto or access the web-based interface before usage of the application. Further, and in this regard, the model selection interface 114 may be supported by the provider institution computing system 122 via one or more servers, processors, network interface circuits, etc. that transmit applications for use to the user device 104. Furthermore, prior to use of the model selection interface 114 and/or at various points throughout the use of the model selection interface 114, the user 102 may be required to provide various authentication information or log-in credentials (e.g., a password, a personal identification number (PIN), an encrypted key, a fingerprint scan, a retinal scan, a voice sample, a face scan, any other type of biometric security scan) to ensure that the user 102 associated with the user device 104 is authorized to use the model selection interface 114.

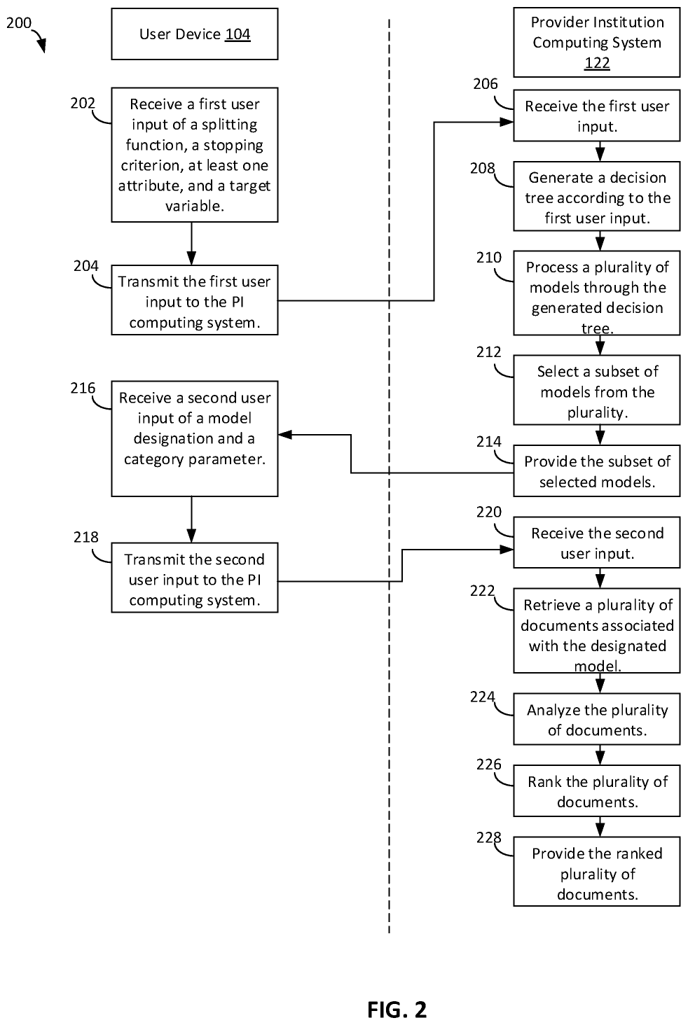

The model selection interface 114 is structured to generate and provide displays to the user 102 of the user device 104 in order to provide information pertaining to data models held at the provider institution 120 and associated with a review or audit process (e.g., as described further with reference to FIG. 2). Accordingly and among potentially other functions, the user may manage aspects of a data model selection process via the model selection interface 114. The model selection interface 114 may be structured to provide a graphical user-interface that enables a user 102 to transmit/receive various inputs/outputs to the provider institution computing system 122 (e.g., as part of a model selection process described herein).

The input/output circuit 116 is structured to receive communications from and provide communications to the user 102. In this regard, the input/output circuit 116 is structured to exchange data, communications, instructions, etc. with an input/output component of the user device 104. In one embodiment, the input/output circuit 116 includes an input/output device. In another embodiment, the input/output circuit 116 includes communication circuitry for facilitating the exchange of data, values, messages, and the like between an input/output device and the components of the user device 104. In yet another embodiment, the input/output circuit 116 includes machine-readable media for facilitating the exchange of information between an input/output device and the components of the user device 104. In still another embodiment, the input/output circuit 116 includes a combination of hardware components, communication circuitry, and machine-readable media.

For example, in some embodiments, the input/output circuit 116 may include suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or manipulation purposes. That is, the input/output circuit 116 provides an interface for the user 102 to interact with various applications (e.g., the model selection interface 114) stored on the user device 104.

Still referring to FIG. 1, the provider institution computing system 122 is associated with (e.g., owned, managed, and/or operated by) the provider institution 120. In the example depicted, the provider institution 120 is a financial institution capable of providing financial data modeling, data model risk analysis, and one or more financial products and services, such as the providing of various accounts, such as a demand deposit account, lending, money transfers, issuing credit and/or debit cards, wealth management, etc. Thus, the associated provider institution computing system 122 is structured to provide or otherwise facilitate providing the one or more financial products and services to customers. As described herein, the provider institution computing system 122 is structured to support at least some of the functions and services described below. As depicted, the provider institution computing system 122 is a backend computer system. The provider institution computing system 122 may be implemented using a computing system, such as a discrete server, a group of two or more computing devices/servers, a distributed computing network, a cloud computing network, and/or another type of computing system capable of accessing and communicating using local and/or global networks (e.g., the network 118).

The provider institution computing system 122 includes a network interface circuit 124, a processing circuit 126, a machine learning circuit 132, a natural language processing (NLP) circuit 134, and an input/output circuit 136. The provider institution computing system 122 also includes a model database 138 and a model risk database 140. In an alternate embodiment, the model database 138 and the model risk database 140 may be a part of another computing system, accessed as needed by the provider institution computing system 122.

The network interface circuit 124 is structured to establish communicable connections with other computing systems (e.g., the user device 104, other computing systems, etc.) by way of the network 118. The network interface circuit 124 may include program logic that facilitates connection of the provider institution computing system 122 to the network 118. For example, the network interface circuit 124 may include a combination of a wireless network transceivers (e.g., a NFC transceiver, a Bluetooth transceiver, a Wi-Fi transceiver, etc.) and/or a wired network transceiver (e.g., an Ethernet transceiver). In some arrangements, the network interface circuit 124 includes the hardware and machine-readable media sufficient to support communication over multiple channels of data communication. Further, in some arrangements, the network interface circuit 124 includes cryptography capabilities to establish a secure or relatively secure communication session in which data communicated over the session is encrypted.

The processing circuit 126 includes a memory 128 and a processor 130. The memory 128 may be one or more devices (e.g., RAM, ROM, Flash memory, hard disk storage) for storing data and/or computer code for completing and/or facilitating the various processes described herein. Memory 128 may be or include non-transient volatile memory, non-volatile memory, and non-transitory computer storage media. Memory 128 may include database components, object code components, script components, or other types of information structured for supporting the various activities and information structures described herein. The memory 128 may be coupled to the processor 130 and include computer code or instructions for executing one or more processes described herein. The processor 130 may be implemented as one or more server processors, application specific integrated circuits (ASIC), field programmable gate arrays (FPGAs), digital signal processor (DSP), microprocessors, or other suitable electronic processing components. The server(s) or server computer may be geographically dispersed relative to other server(s) of the provider institution computing system 122. Further, there may be a variety of different types of server(s) included in the computing system 122 (e.g., application server, database server, catalog sever, communications server, web server, and so on). The memory device may be included with the server(s). The provider institution computing system 122 is configured to run a variety of application programs and store associated data in a database of the memory 128.

The provider institution computing system 122 further includes a machine learning circuit 132. The machine learning circuit 132 is structured to generate and manage machine learning algorithms and data structures (e.g., as part of a model selection process, as described further herein with reference to FIG. 2). Accordingly, the machine learning circuit 132 may be configured to receive parameterized inputs and subsequently initiate a machine learning based process. For example, the machine learning circuit 132 may receive parameters defining a splitting function, a stopping criterion, at least one attribute selection, and a target variable. Responsive to the received parameters, the machine learning circuit 132 may then generate, for example, a decision tree that utilizes the splitting function to generate and split nodes in order to improve homogeny, or purity (e.g., as discussed further below, with reference to FIG. 2), of subsequent sub-nodes. The machine learning circuit 132 may then continue to generate nodes that classify data according to the at least one attribute selection until further node generation provides no benefit (e.g., the nodes at the present depth already provide a conclusion regarding the target variable) or until the stopping criterion is met (e.g., as discussed further below, with reference to FIG. 2). In some arrangements, the machine learning circuit 132 may be structured to generate and manage a recurrent neural network (RNN) instead of a decision tree. In such an arrangement, the machine learning circuit 132 remains configured to receive parameterized inputs from a user and facilitate a subsequent machine learning process (e.g., with an RNN to process data instead of, or in combination with, a decision tree). In this regard, the machine learning circuit 132 may be linked, either tangibly via hardware, or indirectly via software, with the model selection interface 114 of the user device 104.

The natural language processing (NLP) circuit 134 is structured to process any variety of text-based documents in order to parse, analyze, categorize, and derive conclusions regarding the text-based documents. That is, the NLP circuit 134 is further structured to employ any variety of NLP methodologies as part of a text-based analysis. For example, in some arrangements, the NLP circuit 134 may utilize a term frequency-inverse document frequency (TF-IDF) methodology to parse, analyze, and categorize a set of text-based documents (e.g., as discussed further below, with reference to FIG. 2). In other arrangements, the NLP circuit 134 may employ a distributed algorithm (e.g., TextRank), facilitated by an RNN, to parse, analyze, and categorize the set of text-based documents. In this vein, the NLP circuit 134 may be linked, either tangibly via hardware, or indirectly via software, with the machine learning circuit 132 of the provider institution computing system 122. Accordingly, the NLP circuit 134 and the machine learning circuit 132 may be collaboratively employed (e.g., by the user 102, via the model selection interface 114) to process text-based documents.

The input/output circuit 136 of the provider institution computing system 122 is structured to exchange data, communications, instructions, etc. with an input/output component of the provider institution computing system 122 (e.g., a keyboard, a mouse, etc.) (e.g., with a provider institution employee, non-employee, operator, etc.). In one embodiment, the input/output circuit 136 is incorporated into an input/output device. For example, a laptop, desktop, or tablet computer may include the input/output circuit 136 such that the laptop, desktop, or tablet computer is communicably coupled to the provider institution computing system 122. The input/output circuit 136 is structured to receive communications from, and provide communications to, various provider institution 120 employees, agents, or operators associated with the provider institution computing system 122.

The model database 138 is configured to retrievably hold (e.g., in cache memory), store (e.g., in non-transitory memory), categorize, and/or otherwise serve as a repository for information pertaining to data models (e.g., financial data models or other data models, as discussed further herein, with reference to FIG. 2) and documents associated with the data models (e.g., unstructured data associated with the data models). Accordingly, the model database 138 is configured to retrievably store and access information pertaining to a particular data model and a set of associated documents.

The model risk database 140 is configured to retrievably hold (e.g., in cache memory), store (e.g., in non-transitory memory), categorize, and/or otherwise serve as a repository for information pertaining to processed data models (e.g., processed via a decision tree as described further herein with reference to FIG. 2), and NLP processed text-based documents associated with the data models (e.g., processed via TF-IDF as described further herein with reference to FIG. 2). For example, the model risk database 140 may associatively map (e.g., via a one-to-one function) to models in the model database 138, thereby indicating or flagging the associatively mapped data model as a selected data model (e.g., a data model selected for risk review by the method 200). Furthermore, the model risk database 140 is configured to hold structured data produced by the NLP circuit 134. That is, the model risk database 140 may retrievably hold text-based document ratings and any additional structured data produced by an NLP analysis (e.g., via the NLP circuit 134, as discussed further with reference to FIG. 2).

Referring now to FIG. 2, a flow diagram for a method 200 for using a decision tree to select models for risk review, is shown according to an example embodiment. Method 200 may be performed using the system of FIG. 1 such that reference is to the components of FIG. 1 to aid the description of method 200. The method 200 is applicable with the provider institution 120 being a financial institution and, as such, is discussed herein as so.

The method 200 begins at process 202 with the model selection interface 114 of the user device 104 receiving a first input (e.g., from the 102) designating parameters of the decision tree. The input may be received, for example, from a component (e.g., button, checkbox, text entry form, etc.) selection made via a user-interactive graphical user interface (GUI) generated and provided by the model selection interface 114. The parameters include designating a splitting function, a stopping criterion, at least one attribute, and a target variable. The splitting function is a choice of methodology used to split nodes of the decision tree. Node splitting is a process of dividing a node into multiple sub-nodes to create relatively pure or homogenous nodes (e.g., relative to the target variable). That is, at every node, a set of possible split points are identified for every selected attribute (e.g., the at least one attribute). The selected splitting function calculates the improvement in purity of the data that would be created by each split point of each attribute (e.g., according to the function, as described further below). The split with the greatest improvement (e.g., in homogeny/purity) is chosen to partition the data and create sub-nodes. Although certain splitting functions (e.g., Information Gain and Gini Impurity) are described below, it should be appreciated that the method 200 may be performed with other splitting functions as well.

For example, the user 102 may designate Information Gain as the splitting function. Information Gain is used for splitting the nodes when the target variable is categorical (e.g., containing two or more categories without an intrinsic order). Information Gain is based on the concept of entropy, which is represented by the following function:

$$Entropy = - {\sum }_{i = 1}^{n} {p}_{i} {log}_{2} {p}_{i}$$

The entropy of a node is a calculation of the purity of the node, such that the lower the value of entropy, the higher the purity (e.g., the entropy of a homogenous node is zero). The formula for determining the Information Gain of a node is:

$$Information Gain = 1 - Entropy$$

Accordingly, in order to generate a decision tree using Information Gain as a splitting function, the following process is used:
1. For each split, individually calculate the entropy of each sub-node.
2. Calculate the entropy of each split as the weighted average entropy of sub-nodes.
3. Select the split with the lowest entropy or highest information gain.
4. Repeat steps 1-3 until homogeneous nodes are achieved (or until a stopping criterion is met).

In another example, the user 102 may designate Gini Impurity as the splitting function. Gini Impurity is also used for splitting the nodes when the target variable is categorical (e.g., containing two or more categories without an intrinsic order). Gini Impurity is based on the concept of Gini, which is the probability of correctly labeling a randomly chosen element if it was randomly labeled according to the distribution of labels in the node. The lower the Gini Impurity for a node, the higher the homogeny (e.g., a pure/homogenous node has a Gini Impurity of zero). Therefore, the formula for Gini is:

$$Gini = {\sum }_{i = 1}^{n} {p}_{i}^{2}$$

Accordingly, the formula for determining Gini Impurity is:

$$Gini Impurity = 1 - Gini$$

The process for generating a decision tree using Gini Impurity as a splitting function is the same as the process described above for Information Gain, except that instead of calculating entropy and information gain, the Gini Impurity is calculated. In some implementations, Gini Impurity may be preferrable to Information Gain as it does not contain logarithms, which are computationally intensive.

Continuing the discussion above, the parameters include a stopping criterion. In some arrangements, the stopping criterion is a designation of max-depth for the decision tree. That is, each layer of sub-nodes increases the depth of the tree by one, and simultaneously increases the accuracy of decision the tree while decreasing the efficiency, or speed, of the decision tree. In such an arrangement, the user 102 may designate a maximum depth that the decision tree may reach. In other arrangements, the stopping criterion is a designation of node purity, or homogeny (e.g., as calculated by the splitting function). In yet other arrangements, there may be no designation of a stopping criterion and the node generation simply stops according to the splitting function (often causing overfitting). In such arrangements, the decision tree may be pruned to sacrifice accuracy for efficiency. Such a pruning process may follow identical logic as described above with regard to the stopping criterion (e.g., pruning sub-nodes according to a max-depth or purity parameter).

The parameters further include a designation of at least one attribute (e.g., of a data model) and a target variable. Data models often contain many attributes and a user 102 may desire to focus on certain, or specific, attributes according to the goal of the process (e.g., the target variable). For example, consider a scenario where a financial institution (e.g., the provider institution 120) desires to select a subset of data models for risk review (e.g., as part of an audit process). In such a scenario, the data models may contain binary attributes, such as: is the mode quantitative or qualitative; is the model associated with a Consent Order/Matter Requires Attention (MRA), or otherwise regulatory associated; is the model Risk Rank 1 or 2, does the model have model risk findings (MRFs), is the model used for the Comprehensive Capital Analysis and Review (CCAR). The attributes may also be logic or probability based (e.g., does the model have a risk score>3). Utilizing such attributes, the audit process may select a target variable (e.g., the prediction that the decision tree is attempting to make) of, “Should this model be selected for risk review?” It should be noted that the preceding discussion is an example only and the systems and methods described herein are applicable to any data model selection process (e.g., a data model selection process conducted by a technology manufacturer to predict hardware depreciation).

At process 204, the first user input containing the parameter designations is transmitted to the provider institution computing system 122 (e.g., via the network 118). At process 206, the provider institution computing system 122 receives the transmitted first user input. In some arrangements, the transmission may be encrypted for security. In other arrangements, the transmission may occur via an application programming interface (API) and utilize tokenization for security.

At process 208, a decision tree is generated (e.g., created and held in memory 128) according to the received parameter designations (e.g., via the machine learning circuit 132). Generation of the decision tree includes training the tree with a training data set. A training data set is a set of sample data that has been enriched or labeled and, therefore, is analogous to presenting data with known answers to the decision tree. For example, a training data set for an autonomous car logic may include pictures of a road with the various components pre-labeled (e.g., pedestrians, signs, other cars, etc.). This process enables the decision tree to denote a baseline from which to consider other data (e.g., new data not part of the training data). In some arrangements, the decision tree is further cross-validated against a test set of data that tests the accuracy of the decision tree post-training. Generation of the decision tree through the training data set occurs according to the parameter designations. That is, the nodes are created and split according to the splitting function (and until the stopping criterion is met), with the goal of creating leaves (a class or decision stopping point) that correlate to the target variable (e.g., that make a prediction or conclusion about the target variable).

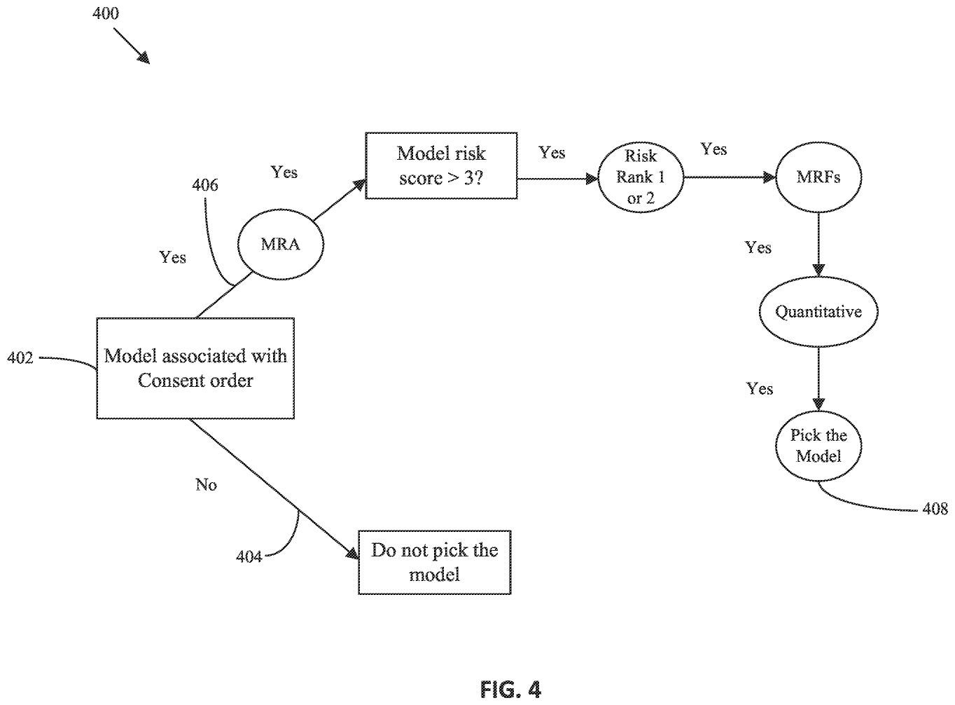

At process 210, a plurality of data models are retrieved from the model database 138 and processed through the decision tree. The retrieval process may be a direct query to the repository 138 (e.g., a native query in MySQL, PostgreSQL, etc.) or, in some arrangements, an API call to a web server that provides data on behalf of the repository. The act of processing the data models includes traversing the nodes of the decision tree until a leaf is encountered (e.g., a stopping point for the data model based on its attributes). That is, the data model traverses the decision tree answering a question (e.g., this can be considered as a linear string of yes's and no's) at each node until it no longer has another node to descend to (e.g., as described further below, with reference to FIG. 4).

At process 212, the provider institution computing system 122 selects a subset of data models from the processed plurality (e.g., according to the decision tree). The selected data models may be flagged (e.g., a one-to-one function mapping to the data model in the model database 138), or retrievably stored, in the model risk database 140. In some arrangements, the linear string of yes's and no's that occurred during the processing may also be stored in the model risk database 140 (e.g., for readability/clarity of display on the generated graphical user-interface of the model selection interface 114).

At process 214, the subset of selected data models are provided (e.g., transmitted over the network 118 for display on the generated graphical user-interface of the model selection interface 114) to the user device 104. In some arrangements, the subset of data models are provided with an editable list displaying the at least one selected attributes to the user 102. In such arrangements, the user 102 may provide a third user input that alters the selected attributes (e.g., adds or removes attributes). Responsive to a change in the selected attributes, the model selection interface 114 may transmit the third user input back to the provider institution computing system 122, causing a real-time update of the generated decision tree and the subset of selected models. For example, the user 102 may initially receive a subset of selected models labeled Model A, Model B, and Model C. However, the user 102 may then decide that, for example, the binary attribute correlating to a model being quantitative is not necessary. Accordingly, the user 102 may alter the selected attributes (e.g., via the model selection interface 114) and submit the change via the generated graphical user interface. The change may then be transmitted to the provider institution computing system 122, causing the machine learning circuit 132 to re-generate the decision tree and re-process the plurality of models. The updated results may then be provided back to the user 102 (e.g., via the generated graphical user interface of the model selection interface 114). Accordingly, the user 102 may subsequently receive back a new subset of selected data models containing Model A, Model B, and Model Q. The process of the aforementioned arrangement may occur in real-time, allowing a user 102 to manipulate the selection process (e.g., based on changes to policy, goals, data model structure, etc.) on the fly. Furthermore, it should be appreciated that the attributes may be altered at any time post-process 214.

At process 216 and 218, the model selection interface 114 receives a second user input of a specific model designation and a category parameter, and transmits them to the provider institution computing system 122 (e.g., via the network 118). The input may be received, for example, from a component (e.g., button, checkbox, text entry form, etc.) selection made via a user-interactive graphical user interface (GUI) generated and provided by the model selection interface 114. The specific model designation represents a user (e.g., the user 102) selection of a model from the subset of selected models (e.g., the user selects a specific model to review from the subset of models flagged for review according to the decision tree). The category parameter may be a topic of interest (e.g., according to the goals of the audit process) that informs the subsequent NLP processing of the documents associated with the model (e.g., as described further below).

At process 220, the provider institution computing system 122 receives (e.g., via the network 118, via API call, etc.) the second user input containing the specific model designation and the category parameter. At process 222, the NLP circuit 134 retrieves a plurality of documents (e.g., text-based documents) associated with the specific model, from the model database 138. The retrieval process may be a direct query to the repository 138 (e.g., a native query in MySQL, PostgreSQL, etc.) or, in some arrangements, an API call to a web server that provides data on behalf of the repository.

At process 224, the NLP circuit 134 analyzes the plurality of documents according to a natural language processing methodology. In some arrangements, the NLP circuit 134 implements a predetermined methodology (e.g., TF-IDF as discussed further below). In other arrangements, the NLP circuit 134 implements a methodology as defined by the user (e.g., the user 102, via the model selection interface 114). For example, in some arrangements, the NLP circuit 134 may utilize TF-IDF in order to analyze and/or process the text from the text-based plurality of documents. TF-IDF is an information retrieval process that treats documents as a “bag-of-words” by parsing each document into individual words. Furthermore, the process then evaluates how relevant, or important, each word is to its originating document and to the plurality of documents as a whole. Practically, this is accomplished by multiplying two metrics: how many times a word appears in a specific document (term frequency), and the inverse document frequency of the word across the plurality of documents as a whole. The term frequency may be calculated in various manners, from a raw count of the instances of a word, to a raw count modified by, for example, the length of the document or the raw frequency of the most frequent word in the document. The inverse document frequency of the word represents how common or rare a word is across the plurality of documents (associated with the specific model). This metric may be evaluated by taking the total number of documents (in the plurality), dividing that number by the number of documents in the plurality that contain the term (word), and subsequently calculating the results logarithm. Proximity to zero represents a high frequency (common), whereas a low frequency (rare) word will approach one. It should be noted that the preceding description of TF-IDF is provided as an example, and modifications to the process (e.g., such as the length of document modifier described above) are applicable to the method 200 as well.

In some arrangements, the process 224 may utilize a distributed algorithm to analyze the plurality of documents (associated with the specific model). For example, the NLP circuit 134 may collaborate with the machine learning circuit 132 to implement, for example, a TextRank algorithm across a recurrent neural network. The TextRank algorithm is based on the PageRank algorithm developed by Google, replacing webpages with sentences and link transitions with sentence similarity measurements. It should be noted that any combination of machine learning techniques implemented by the machine learning circuit 132, and natural language processing implemented by the NLP circuit 134, is applicable to the method 200 as well. Accordingly, such an arrangement utilizing TextRank and an RNN represents an alternative embodiment to the TF-IDF process described above.

At process 226, the plurality of documents associated with the specific model are ranked according to the category parameter. For example, the user 102 may have selected Model A and input a category parameter of “interest rate”. In such an example, the NLP circuit 134 may rank the retrieved plurality of documents associated with Model A based on the TF-IDF score (e.g., as described above). In some arrangements, the ranked documents may be retrievably stored (e.g., via native or API call) in the model risk database 140. Accordingly, it should be appreciated that the process of ranking documents associated with a model selected for risk review, and based on a specific term of interest (e.g., the category parameter) provides a tangible improvement to the efficiency of the field of model auditing. The process of ranking the documents enables a user (e.g., the user 102) to quickly navigate the associated plurality of documents, regardless of quantity.

At process 228, the ranked plurality of documents are provided (e.g., transmitted over the network 118 for display on the generated graphical user-interface of the model selection interface 114) to the user device 104. In some arrangements, the ranked plurality of documents are provided in a pre-sorted (e.g., sorted by the NLP circuit 134) list, where the documents with the highest TF-IDF score (based on the category parameter) are displayed at the top of the list. Furthermore, in some arrangements, the ranked list is editable in real-time (similar to the description of real-time alterations in process 214). That is, the user 102 may input a new category parameter (e.g., input into the generated graphical user-interface of the model selection interface 114) and transmit it back to the provider institution computing system 122 (e.g., via the network 118). In such an arrangement, the NLP circuit 134 may then re-rank the plurality of documents (e.g., according to the description of process 226) and provide the updated rankings in real-time (to the user 102, via the model selection interface 114).

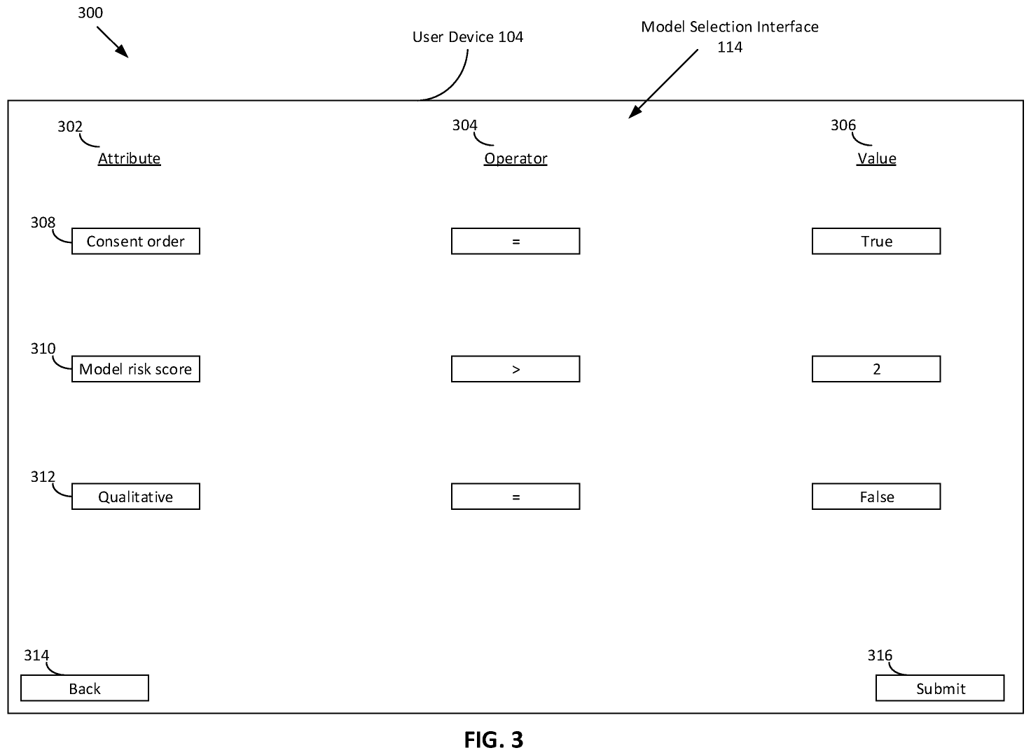

Referring now to FIG. 3, an illustrative example of a user device 104 graphical user-interface 300 displayed as part of a model selection process is shown. In the depicted embodiment, the user device 104 display is a graphical user-interface generated by the model selection interface 114 and designed to facilitate the selection of the at least one user attribute, as described in the method 200.

The display of 300 includes section columns 302, 304, and 306; section rows 308, 310, and 312; a “Back” button 314; and a “Submit” button 316. The section columns 302, 304, and 306 are depicted as textual (e.g., Strings) titles which identify the data held in the rows below them. For example, section column 302, “Attribute”, identifies the contents of the rows below as attribute labels. Continuing, section column 304, “Operator”, identifies the contents of the rows below as operators (e.g., to apply to the corresponding attribute). Section column 306, “Value”, identifies the contents of the rows below as values (e.g., to be used with the corresponding operator, thus creating an equation across the row).

Therefore, the section rows 308, 310, and 312 represent an attribute logic, or equation, containing the selected attribute, an operator, and a value. The section rows 308, 310, and 312 are structured as text-entry fields as depicted. For example, section row 308 defines a selected attribute (e.g., for the method 200) of “Consent order =True”. In other words, the data model must be associated with a consent order. Similarly, section row 310 defines a selected attribute of “Model risk score>2”. Section row 312 defines a selected attribute of “Qualitative =False” (e.g., the model must not be a qualitative model).

The display 300 includes a “Back” button 314. The button 314 is a selectable (e.g., clickable) button of the provided graphical user-interface that transitions the user 102 back to a previous display (not depicted), without initiating the process 208 of method 200.

The “Submit” button 316 is a selectable (e.g., clickable) button of the provided graphical user-interface which, in response to being selected, initiates the process 208 of method 200 (e.g., after transmission in process 204). Accordingly, the attributes represented by the logic, or equations, of section rows 308, 310, and 312 may subsequently be utilized in the generation of a decision tree (e.g., as discussed above, with reference to FIG. 2).

Referring now to FIG. 4, an illustrative example of a linear decision process 400 produced by a decision tree is shown. The linear decision process 400 illustrates a series of questions (e.g., decision tree nodes) about the attributes of a data model as they relate to a target variable, which when answered with a yes or a no (e.g., branch of the decision tree formed during the splitting process, as described above in method 200) results in the classification (e.g., leaves of the decision tree) of said data model. The depicted linear decision process 400 represents an example decision process produced by a financial institution executing the method 200 (e.g., as described with reference to FIG. 2).

The linear decision process 400 includes a root node 402, decision branches 404 and 406, and a leaf 408. The root node 402 represents the initial question, determined by the decision tree (e.g., of method 200), which best (e.g., according to the selected splitting function) classifies the plurality of data models. In the depicted example, the classification pertains to picking a model for review, such as in the audit scenario described above in FIG. 2. Thus, in the depicted example, the determination of whether or not a specific data model is associated with a Consent order represents the question which most homogenously, or purely, splits the plurality of data models with regard to the target variable of picking a model for risk review.

The plurality of data models are split according to the result of the question presented at each node, indicated by decision branches 404 and 406. For example, if a data model is not associated with a Consent order (e.g., determined at root node 402), the data model follows decision branch 404 to a leaf that classifies the data model as a “Do not pick the model” (e.g., for risk review) class. Contrarily, if the data model is associated with a Consent order it may traverse decision branch 406, where it subsequently encounters a sub-node (e.g., new question). In the depicted example, the subsequent encountered sub-node, “MRA”, determines whether the data model has an attribute flagging it as containing matters requiring attention. Furthermore, it should be noted that the example linear decision process 400 is depicted from this point on with only the series of nodes and “yes” branches which result in the quickest, risk review required, classification of the data model (e.g., “Pick the Model” 408). However, any degree of complexity (e.g., in branching quantity) and node quantity may be produced by the method 200 (e.g., according to the user inputs, as described above with reference to FIG. 2). Therefore, in the depicted example, the leaf 408, “Pick the model”, may be reached by any data model that simultaneously has attributes which identify it as being associated with a Consent order, containing matters requiring attention, containing a model risk score greater than three (3), labeled as either Risk Rank 1 or 2, containing model risk findings (MRFs), and as being a quantitative model.

The above-described systems and methods describe a model selection computing system that enables a user to quickly, conveniently, and objectively conduct a model risk review, or audit. The described systems and methods serve to improve the technological field of at least model auditing, as reflected in improvements in convenience and standardization. Accordingly, by enabling a user to select a model for review in a standardized and objective fashion, a model audit may be completed in a manner that comports with regulatory guidance.

While this specification contains many specific implementation details and/or arrangement details, these should not be construed as limitations on the scope of any inventions or of what may be claimed, but rather as descriptions of features specific to particular implementations and/or arrangements of the systems and methods described herein. Certain features that are described in this specification in the context of separate implementations and/or arrangements can also be implemented and/or arranged in combination in a single implementation and/or arrangement. Conversely, various features that are described in the context of a single implementation and/or arrangement can also be implemented and arranged in multiple implementations and/or arrangements separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

It should be understood that no claim element herein is to be construed under the provisions of 35 U.S.C. § 112 (f), unless the element is expressly recited using the phrase “means for.”

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A method for model selection, the method comprising:
receiving, by a provider institution computing system, a first user input comprising an identifier of a splitting function, a stopping criterion, at least one attribute selection, and a target variable;
training, by the provider institution computing system, a decision tree model based on the received first user input, wherein training includes processing a training data set to:
create a node that splits the training data set on an attribute from the at least one attribute selection;
split the node according to the splitting function identified in the first user input; and
iteratively repeat training of the decision tree model until the stopping criterion is met;
pruning, by the provider institution computing system, the decision tree model to improve the efficiency of executing the decision tree model;
processing, by the provider institution computing system, a plurality of models through the trained decision tree, wherein processing includes a determination about the target variable for each model from the plurality of models;
selecting, by the provider institution computing system, a subset of models from the plurality of models based on the determination of the target variable;
providing, by the provider institution computing system, the subset of selected models to a user;
receiving, by the provider institution computing system, a second user input comprising a category parameter and a designation of at least one model from the subset of selected models;
retrieving, by the provider institution computing system, a plurality of documents associated with the designated at least one model;
analyzing, by the provider institution computing system, the plurality of documents via a natural language processing (NLP) algorithm;
ranking, by the provider institution computing system, the plurality of documents based on the NLP algorithm and the received category parameter; and
providing, by the provider institution computing system, the ranked plurality of documents to the user.

2. The method for model selection of claim 1, wherein the splitting function is one of Information Gain, Gini Impurity, and Chi-Square.

3. The method for model selection of claim 1, wherein the stopping criterion is a designation of node depth for the decision tree model.

4. The method for model selection of claim 1, wherein the stopping criterion is a designation of node purity for the decision tree model.

5. The method for model selection of claim 1, further comprising:
receiving, by the provider institution computing system, a third user input comprising an addition or a removal of at least one attribute;
re-training, by the provider institution computing system, the decision tree model based on the received third user input;
re-processing and selecting, by the provider institution computing system, the plurality of models through the re-trained decision tree; and
updating, in real-time and by the provider institution computing system, the provided subset of selected models.

6. The method for model selection of claim 1, further comprising:
receiving, by the provider institution computing system, a third user input comprising a new category parameter;
re-analyzing, by the provider institution computing system, the plurality of documents based on the new category parameter;
re-ranking, by the provider institution computing system, the plurality of documents; and
updating and providing, in real-time and by the provider institution computing system, the ranked plurality of documents to the user.

7. The method for model selection of claim 1, wherein the NLP algorithm is based on a term frequency-inverse document frequency process.

8. The method for model selection of claim 1, wherein the NLP algorithm utilizes a recurrent neural network.

9. The method for model selection of claim 8, wherein the NLP algorithm is based on a TextRank process.

10. A model selection computing system comprising:
a machine learning circuit;
a natural language processing (NLP) circuit;
a model database;
a model risk database; and
a processing circuit configured to:
receive a first user input comprising an identifier of a splitting function, a stopping criterion, at least one attribute selection, and a target variable;
train a decision tree model based on the received first user input, wherein training includes processing a training data set to:
create a node that splits the training data set on an attribute from the at least one attribute selection;
split the node according to the splitting function identified in the first user input; and
iteratively repeat training of the decision tree model until the stopping criterion is met;
prune the decision tree model to improve the efficiency of executing the decision tree model;
process a plurality of models through the trained decision tree, wherein processing includes a determination about the target variable for each model from the plurality of models;
select a subset of models from the plurality of models based on the determination of the target variable;
provide the subset of selected models to a user;
receive a second user input comprising a category parameter and a designation of at least one model from the subset of selected models;
retrieve a plurality of documents associated with the designated at least one model;
analyze the plurality of documents via a natural language processing (NLP) algorithm;
rank the plurality of documents based on the NLP algorithm and the received category parameter; and
provide the ranked plurality of documents to the user.

11. The model selection computing system of claim 10, wherein the splitting function is one of Information Gain, Gini Impurity, and Chi-Square.

12. The model selection computing system of claim 10, wherein the stopping criterion is a designation of node depth for the decision tree model.

13. The model selection computing system of claim 10, wherein the stopping criterion is a designation of node purity for the decision tree model.

14. The model selection computing system of claim 10, further comprising:
receive a third user input comprising an addition or a removal of at least one attribute;
re-train the decision tree model based on the received third user input;
re-process and select, the plurality of models through the re-trained decision tree; and
update, in real-time, the provided subset of selected models.

15. The model selection computing system of claim 10, further comprising:
receive a third user input comprising a new category parameter;
re-analyze the plurality of documents based on the new category parameter;
re-rank the plurality of documents; and
update and provide, in real-time, the ranked plurality of documents to the user.

16. The model selection computing system of claim 10, wherein the NLP algorithm is based on a term frequency-inverse document frequency process.

17. The model selection computing system of claim 10, wherein the NLP algorithm utilizes a recurrent neural network.

18. The model selection computing system of claim 17, wherein the NLP algorithm is based on a TextRank process.

19. A non-transitory computer-readable medium comprising instructions stored thereon that, when executed by a processor of a computing system, cause the computing system to perform operations comprising:
receive a first user input comprising a splitting function, a stopping criterion, at least one attribute selection, and a target variable;
train a decision tree model based on the received first user input, wherein training includes processing a training data set to:
create a node that splits the training data set on an attribute from the at least one attribute selection;
split the node according to the splitting function identified in the first user input; and
iteratively repeat training of the decision tree model until the stopping criterion is met;
prune the decision tree model to improve the efficiency of executing the decision tree model;
process a plurality of models through the trained decision tree, wherein processing includes a determination about the target variable for each model from the plurality of models;
select a subset of models from the plurality of models based on the determination of the target variable;
provide the subset of selected models to a user;
receive a second user input comprising a category parameter and a designation of at least one model from the subset of selected models;
retrieve a plurality of documents associated with the designated at least one model;
analyze the plurality of documents via a natural language processing (NLP) algorithm;
rank the plurality of documents based on the NLP algorithm and the received category parameter; and
provide the ranked plurality of documents to the user.

20. The non-transitory computer-readable medium of claim 19, wherein the splitting function is one of Information Gain, Gini Impurity, and Chi-Square.
